(19) United States
(12) Patent Application Publication
(10) Pub. No.: US 2004/0225925 A1
(43) Pub. Date: Nov. 11, 2004

(54) Method for detecting computer memory access errors

(76) Inventor: Chien-Yu Chen, Taipei (TW)

Correspondence Address: BIRCH STEWART KOLASCH & BIRCH, PO BOX 747, FALLS CHURCH, VA, 22040-0747, US

(21) Appl. No.: 10/834,912

(22) Filed: Apr. 30, 2004

(30) Foreign Application Priority Data
May 9, 2003 (TW) 092112630

(51) Int. Cl. H04L 1/22; G06F 12/00

(52) U.S. Cl. 714/42; 711/170

(57) ABSTRACT

The present invention relates to a method for detecting computer memory access errors by adding a head and a tail to an allocated memory block. Since the bound violation occurred when the memory accessed falls outside the address range of the allocated memory block, the present invention adds a head and a tail to the allocated memory block, wherein the size of the two, head and tail, can be the same, moreover, the head and the tail respectively comprises: a State_flag for representing the current state of the memory block, and a Mem_size for representing the actual memory size used.

### BACKGROUND OF THE INVENTION

(a). Field of the Invention

The present invention relates to a method for detecting computer memory access errors, more particularly, to a method for detecting a computer memory access error while writing in, reading from, or releasing the memory by adding a header and tail to the memory space.

(b). Description of the Prior Arts

Developments in today's computers in both hardware and software have come into a level that a consumer can acquire a powerful personal computer (PC) with a very low price. In the mean time that the development of designing application program is highly regarded as a key technology to upgrade the level of industrial development. Moreover, today's world of computer programming offers many high-level programming languages. The flexibility and power offered by programming languages, such as Assembly, C, C++, etc., have made these languages very popular among programmers. During the execution of a computer program, errors due to memory accessing, such as array bounds violations, errors of reading from uninitialized memory, and free the memory space that has been freed, will happen that may crash the system or make the system unpredictable, and it is difficult to find those problems if we don't use any protection technique, such as a checking mechanism. In the prior art, in order to find the memory access error, there are many techniques that provide memory check mechanism. These techniques usually use a table built in the system to store the memory state indicating the memory allocation status of all the accessible memory address. During memory accessing, the program has to check the memory state using the forgoing table to confirm the validatity and size of the memory space. However, the aforementioned method according to the prior art requires accessing the table a plurality of times that, in consequence, is going to consume a lot more memory space for accommodating the plural tables. Hence, the method of the prior art will reduce the performance of the computer system, and is also difficult to detect memory access errors in real-time. In this regard, for a program of a high pipeline structured digital signal processor (DSP), any memory check or memory access will break the pipeline structure, more specifically, in the real-time system, the memory accessing latency may influence the schedule of other tasks. The present invention is a method for detecting memory access errors that is capable of solving the aforementioned shortcoming of the prior art and is helpful in reducing program development time.

### SUMMARY OF THE INVENTION

The primary object of the present invention is to provide a method to detect the memory access error suitable for DSP application. That is, once a memory block is allocated by a program, the checking mechanism of the present invention adds a head and a tail to the memory block for protecting the memory block. And, during the memory accessing, a pointer is sent to a check function to check if the memory is valid. Moreover, a memory free function also has to confirm the header and the tail in the memory block before releasing the memory block. This method can prevent the memory access errors, such as array bounds violations, errors of reading from uninitialized memory, and free the memory space that has been freed. Besides, the method according to the present invention is simple and does not require extra tables to record the memory status that is suitable for DSP real-time system.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a diagram schematically illustrating a head and tail addition for memory access error protection according to the present invention.

FIG. 2 is a flowchart of the memory allocation function according to the present invention.

FIG. 3 is a flowchart of the memory write/check function according to the present invention.

FIG. 4 is a flowchart of the memory read/check function according to the present invention.

FIG. 5 is a flowchart of the memory free function according to the present invention.

### DETAILED DESCRIPTION OF THE PRESENT INVENTION

Throughout this description, the preferred embodiment and examples shown should be considered as exemplars, rather than limitations on the method of the present invention. For example, although the following discussion is presented in the context of use with the C programming language, the inventive concepts can be readily applied to any computer language

In a preferred embodiment, the present invention comprises a set of computer program subroutines which are counterparts of, and substituted for, standard memory allocation subroutines. For example, the memory allocation check mechanism is a function adding some code of head/tail addition before “malloc” function in C. It replaces the original “malloc” function in the original program. The memory free check mechanism is a function adding some code of head/tail checking and removing before the “free” function in C. It replaces the original “free” function in the original program. And the memory validation function is an independent function that checks the head and tail of the memory block.

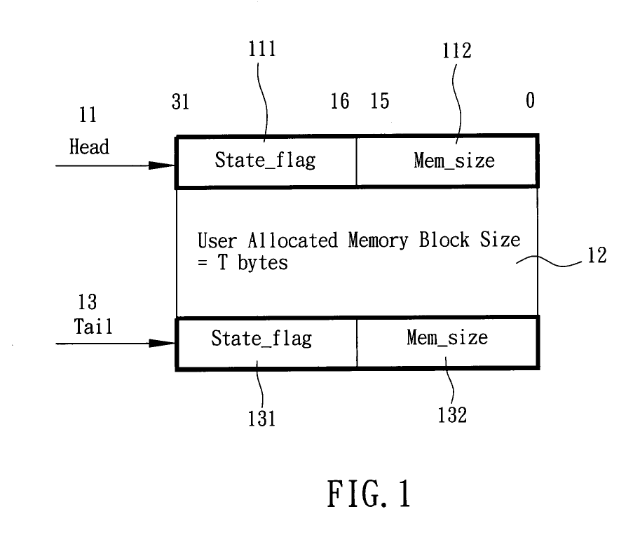

Please refer to FIG. 1, which is a diagram schematically illustrating a head and tail added to a dynamically allocated memory block according to the present invention. Since the bound violation occurred when the memory accessed falls outside the address range of the allocated memory block, the present invention adds a head 11 and a tail 13 to the allocated memory block 12, wherein the size of the two, head and tail, can be the same, moreover, the head and the tail respectively comprises: a State_flag for representing the current state of the memory block 12, and a Mem_size for representing the actual memory size used.

As seen in FIG. 1, a head 11 and a tail 13 are added to every dynamically allocated memory block, wherein the head 11 comprises a State_flag 111 and a Mem_size 112, moreover, the tail 13 also comprises a State_flag 131 and a Mem_size 132. Take a 32-bit processor for example, when user program requests allocating a memory block with size of T bytes, the memory allocation function of the present invention, which is represented as MEM_allocate( ) hereinafter, allocates a T+8 bytes that the head 11 and the tail 12 respectively occupies 4 bits and contain therein the same information.

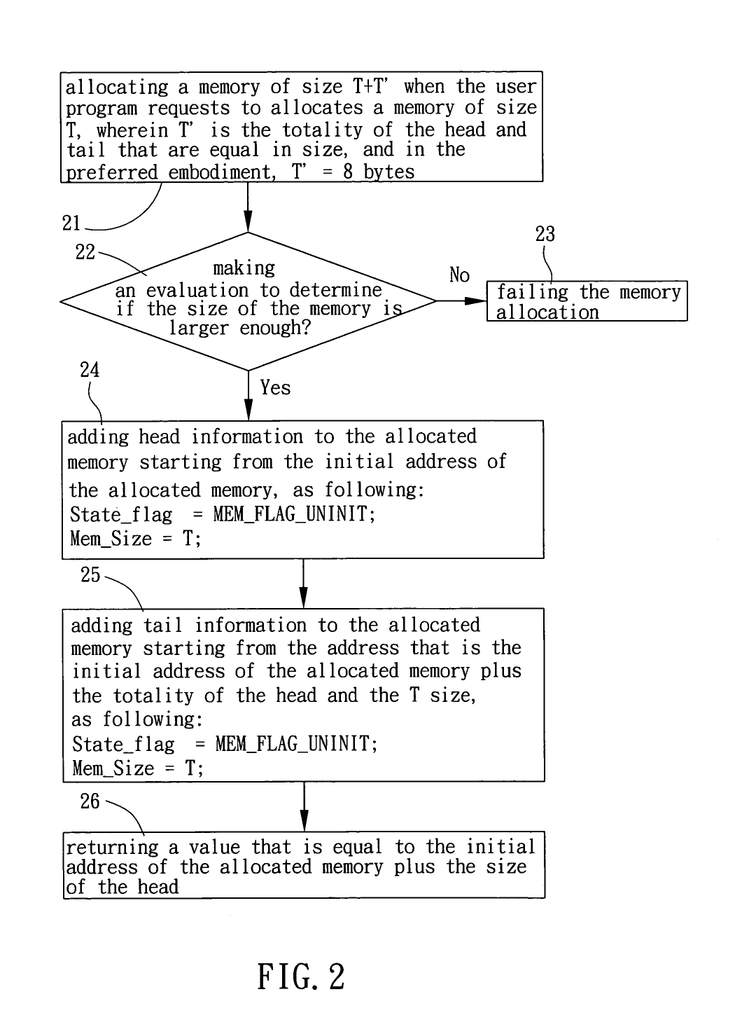

Please refer to FIG. 2, which is a flowchart illustrating the memory allocation function, i.e. MEM_allocate( ), according to the present invention. When a new memory block is allocated, the new memory block is in an allocated but uninitialized state, that is, the State_flag is set to be MEM_FLAG_UNINIT and the Mem_SIZE field is filled with the size of the allocated memory size T. Also noted that the return value of the MEM_allocate( ) is the address after the head if the allocation is a success, or is a value symbolizing fail if the allocation is not a success. The processing steps of the MEM_allocate( ) comprises:

(21) allocating a memory of size T+T′ when the user program requests to allocates a memory of size T, wherein T′ is the totality of the head and tail that are equal in size, and in the preferred embodiment, T′=8 bytes;

(22) making an evaluation to determine if the size of the memory is larger enough? If so, execute the step (25); if not, execute the step (24);

(23) failing the memory allocation;

(24) adding head information to the allocated memory starting from the initial address of the allocated memory, as following:

State_flag=MEM_FLAG_UNINIT;

Mem_Size=T;

(25) adding tail information to the allocated memory starting from the address that is the initial address of the allocated memory plus the totality of the head and the T size, as following:

State_flag=MEM_FLAG_UNINIT;

Mem_Size=T;

(26) returning a value that is equal to the initial address of the allocated memory plus the size of the head.

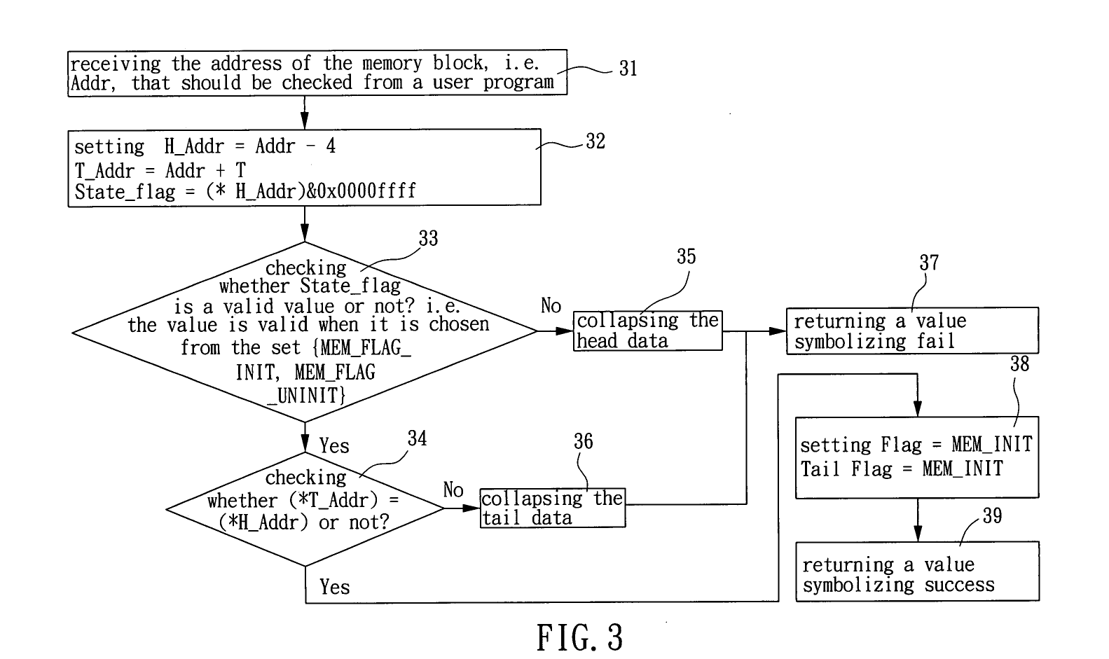

Please refer to FIG. 3, which is a flowchart illustrating a memory checking during a memory write operation, i.e. MEM_write_check( ), according to the present invention. A brief description of the function is as following: After a memory block is written by a program for the first time, the memory block becomes readable. That is, after the program writes data to the memory block, the State_flag of the head and tail of the memory block should be modified to MEM_FLAG_INIT, i.e. the memory block has been initialized. Besides, after the foregoing memory write operation is finished, the head and tail of the memory block should and can be check for the prevention of bounds violation error. The processing steps of the MEM_write_check ( ) comprises:

(31) receiving the address of the memory block, i.e. Addr, that should be checked from a user program;

(32) setting

H_Addr=Addr−4, i.e. the address of the head;

T_Addr=Addr+T, i.e. the address of the tail;

State_flag=(* H_Addr)&0x0000ffff;

(33) checking whether State_flag is a valid value or not? i.e. the value is valid when it is chosen from the set {MEM_FLAG_INIT, MEM_FLAG_UNINIT}; if valid, execute the step (34); if not, execute the step (35); P1 (34) checking whether (*T_Addr)=(*H_Addr) or not? If so, execute the step (38); if not, execute the step (36);

(35) collapsing the head data; execute the step (37);

(36) collapsing the tail data; execute the step (37);

(37) returning a value symbolizing fail;

(38) setting Flag=MEM_INIT;

Tail Flag=MEM_INIT;

(39) returning a value symbolizing success;

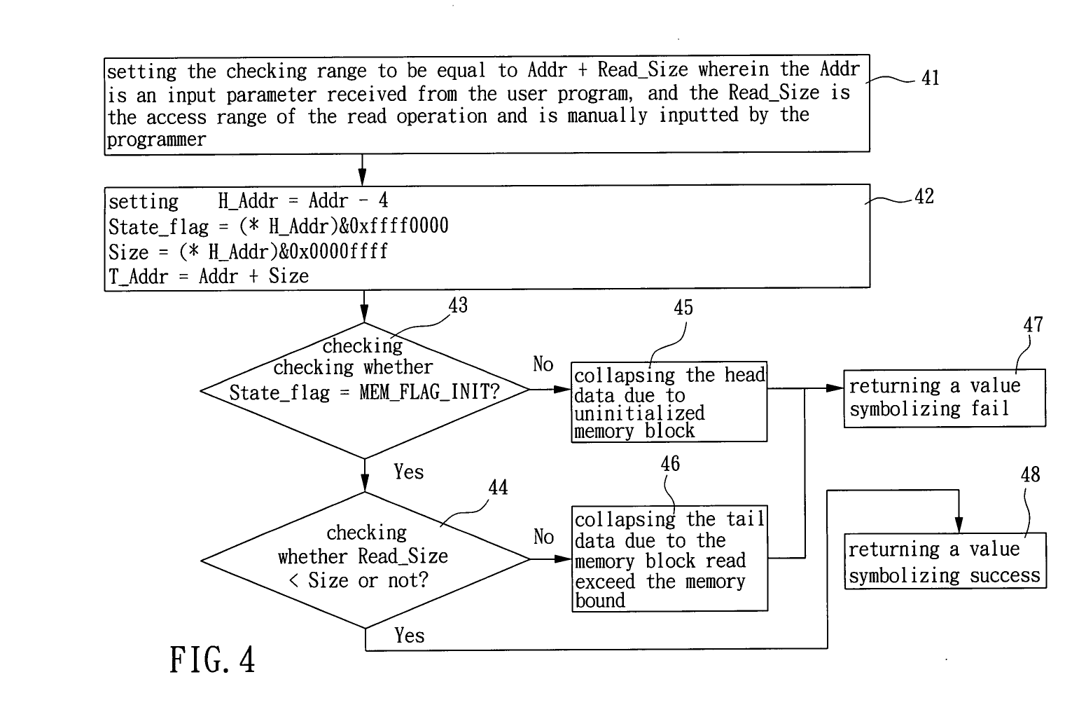

Please refer to FIG. 4, which is a flowchart illustrating a memory checking during a memory read operation, i.e. MEM_read_check( ), according to the present invention. A brief description of the function is as following: The read operation of the memory block, on the other hand, doesn't have to check the head and the tail after memory access. However, to ensure that the memory block is initialized, the State_flag should be checked before the read operation. That is, only in MEM_FLAG_INIT state that the program is able to read the memory block. The processing steps of the MEM_read_check ( ) comprises:

(41) setting the checking range to be equal to Addr+Read_Size wherein the Addr is an input parameter received from the user program, and the Read_Size is the access range of the read operation and is manually inputted by the programmer;

(42) setting

H_Addr=Addr−4, i.e. the address of the head;

State_flag=(* H_Addr)&0xffff0000;

Size=(* H_Addr)&0x0000ffff;

T_Addr=Addr+Size, i.e. the address of the tail;

(43) checking whether State_flag=MEM_FLAG_INIT? If so, execute the step (44); if not, execute the step (45);

(44) checking whether Read_Size<Size or not? If so, execute the step (48); if not, execute the step (46);

(45) collapsing the head data due to uninitialized memory block; execute the step (47);

(46) collapsing the tail data due to the memory block read exceed the memory bound; execute the step (47);

(47) returning a value symbolizing fail;

(48) returning a value symbolizing success;

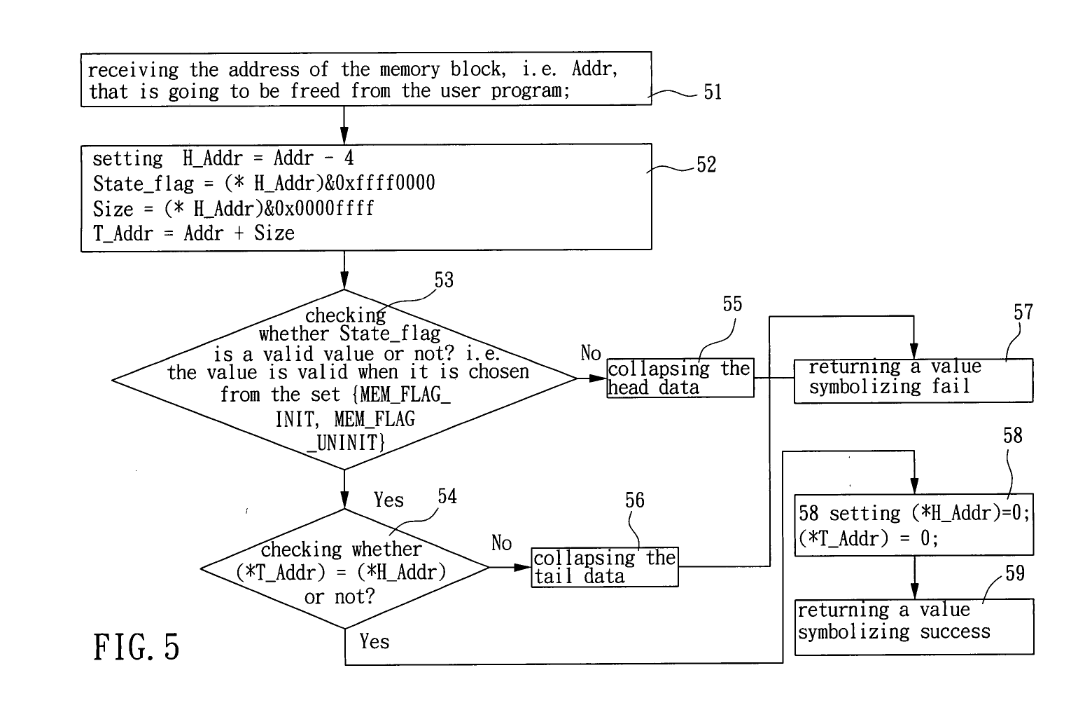

Please refer to FIG. 5, which is a flowchart illustrating a memory release operation, i.e. MEM_release( ), according to the present invention. A brief description of the function is as following: In memory release operation, the user program has to check the head and tail to make sure that the memory block boundary is not overwritten by erroneous memory accessing. Note that in MEM_write_check( ), MEM_read_check( ), and MEM_release( ), these functions get the returned address of MEM_allocate( ) from the user program, and the real head address is the program input address minus by 4 bytes.

(51) receiving the address of the memory block, i.e. Addr, that is going to be freed from the user program;

(52) setting

H_Addr=Addr−4; i.e. the address of the head;

State_flag=(* H_Addr)&0xffff0000;

Size=(* H_Addr)&0x0000ffff;

T_Addr=Addr+Size, i.e. the address of the tail;

(53) checking whether State_flag is a valid value or not? i.e. the value is valid when it is chosen from the set {MEM_FLAG_INIT, MEM_FLAG_UNINIT}; if valid, execute the step (54); if not, execute the step (55);

(54) checking whether (*T_Addr)=(*H_Addr) or not? If so, execute the step (58); if not, execute the step (56);

(55) collapsing the head data; execute the step (57);

(56) collapsing the tail data; execute the step (57);

(57) returning a value symbolizing fail;

(58) setting

(*H_Addr)=0;

(*T_Addr)=0;

(59) returning a value symbolizing success;

The present invention proposes a simple block-based memory check mechanism that is able to prevent the errors, such as memory bound access violation, uninitialized memory access and free memory access, from happening with reference to FIG. 1˜FIG. 5. The architecture of the present invention does not allocate any pre-defined table recording related memory information, and the function does not check for each memory element. Hence, it is suitable for DSP real-time system application to erroneous memory access from happening in debugging phase.

While the present invention has been shown and described with reference to a preferred embodiment thereof, and in terms of the illustrative drawings, it should be not considered as limited thereby. Various possible modification, omission, and alterations could be conceived of by one skilled in the art to the form and the content of any particular embodiment, without departing from the scope and the sprit of the present invention.

What is claimed is:

1. A method for detecting memory access errors by adding a head and a tail to an allocated memory block, wherein the head and the tail respectively comprising a state flag (State_flag) and a memory size (Mem_Size) which are used for checking erroneous memory access.

2. The method for detecting memory access errors of claim 1, wherein the state flag represents the current state of the memory block

3. The method for detecting memory access errors of claim 1, wherein the head and the tail comprise identical.

4. The method for detecting memory access errors of claim 3, wherein the size of the head is equal to the size of the tail.

5. The method for detecting memory access errors of claim 1, wherein the head and the tail comprise information that can be used in steps of the following operation: a memory allocating operation, a memory writing operation, a memory reading operation and a memory freeing operation.

6. A method of memory allocation checking, comprising the steps of:
(a1) allocating a memory block of size T+T′ when the user program requests to allocates a memory of size T, wherein T′ is the totality of a head and a tail;
(b1) returning a value symbolizing validity of the memory block;
(c1) adding head information to the allocated memory block starting from the initial address, represented as Addr, of the memory block, that is, setting the value of a parameter Mem_Size stored inside the head to be equal to T;
(d1) adding tail information to the allocated memory block starting from the address that is the initial address of the memory block plus the totality of the head and the T size; and
(e1) returning a address that is equal to the initial address of the allocated memory plus the size of the head.

7. The method of memory allocation checking of claim 6, wherein the step (c1) further comprises a step: setting a parameter State_flag stored in the head to a value representing flag of uninitialized memory.

8. The method of memory allocation checking of claim 6, wherein the step (d1) further comprises a step: setting a parameter State_flag stored in the tail to a value representing flag of uninitialized memory.

9. The method of memory allocation checking of claim 6, wherein the step (a1) further comprises a step for failing the memory allocation while a value symbolizing invalidity of the memory block is returned.

10. The method of memory allocation checking of claim 6, wherein the memory block is valid for performing a memory writing operation, moreover, after the memory writing operation, the head and the tail should be checked for preventing bounds violation from happening, comprising the steps as following:
(a2) receiving a parameter of the address, i.e. Addr, while the user program writing data into the memory block;
(b2) setting
H_Addr=Addr−4;
T_Addr=Addr+T;
State_flag=(* H_Addr)&0x0000ffff;
(c2) checking whether State_flag is equal to the flag of the memory block (MEM_FLAG) or not? if so, execute the step (d2); if not, returning a value symbolizing fail;
(d2) checking whether (*T_Addr)=(*H_Addr) or not? If so, execute the step (f2); if not, returning a value symbolizing fail;
(e2) setting the Flag for representing the memory block is in a initialized state in both the head and the tail;
(f2) returning a value symbolizing success.

11. The method of memory allocation checking of claim 6, wherein the memory block is valid for performing a memory reading operation, moreover, before the memory reading operation, the head and the tail should be checked to ensure the memory block is initialized, comprising the steps as following:
(a3) setting a checking range to be equal to Addr+Read_Size wherein the Addr is an input parameter received from the user program, and the Read_Size is the access range of the read operation and is manually inputted by the programmer;
(b3) setting
H_Addr=Addr−4;
State_flag=(* H_Addr)&0xffff0000;
T_Addr=Addr+T;
(c3) checking whether State_flag is equal to the parameter representing the memory block is in a initialized state? If so, execute the step (d3); if not, returning a value symbolizing fail;
(d3) checking whether Read_Size<T or not? If so, execute the step (e3); if not, returning a value symbolizing fail;
(e3) returning a value symbolizing success;

12. The method of memory allocation checking of claim 6, wherein the memory block is valid, moreover, in a memory free operation, the head and the tail should be checked to ensure the memory block is not overwritten by erroneous memory accessing, comprising the steps as following
(a4) receiving a parameter of the address, i.e. Addr, from the user program;
(b4) setting
H_Addr=Addr−4;
State_flag=(* H_Addr)&0xffff0000;
T_Addr=Addr+T;
(c4) checking whether State_flag is equal to the parameter representing the memory block is in a initialized state? If so, execute the step (d4); if not, returning a value symbolizing fail;
(d4) checking whether (*T_Addr)=(*H_Addr) or not? If so, execute the step (e4); returning a value symbolizing fail;
(e4) setting
(*H_Addr)=0;
(*T_Addr)=0;
(f5) returning a value symbolizing success;
